(19) United States
(12) Patent Application Publication
(10) Pub. No.: US 2006/0018729 A1
(43) Pub. Date: Jan. 26, 2006

(54) MOBILE MOTORCYCLE BURNOUT PIT

(76) Inventor: Curtis Kooy, Crown Point, IN (US)

Correspondence Address: HARTMAN & HARTMAN, P.C., 552 EAST 700 NORTH, VALPARAISO, IN, 46383, US

(21) Appl. No.: 10/908,751

(22) Filed: May 25, 2005

Related U.S. Application Data
(60) Provisional application No. 60/521,571, filed on May 26, 2004.

(51) Int. Cl. B60P 3/06

(52) U.S. Cl. 410/7

(57) ABSTRACT

A mobile motorcycle burnout pit that includes a wheeled flatbed, an apparatus for supporting a front wheel of a motorcycle in an upright position on the floor of the flatbed, a guide attached to the floor of the flatbed rearward of the front wheel supporting apparatus, and a burnout pad replaceably secured with the guide on the floor of the flatbed. The burnout pad is sized and located relative to the front wheel supporting apparatus for supporting a rear wheel of the motorcycle during a burnout session.

This application claims the benefit of U.S. Provisional Application No. 60/521,571, filed May 26, 2004.

### BACKGROUND OF THE INVENTION

The present invention generally relates to motorcycles and entertainment equipment that can be used therewith. More particularly, this invention relates to a portable motorcycle burnout pit.

Traditional motorcycle burnout pits have been stationary and expensive. For example, because conventional burnout pits are stationary, a motorcyclist must bring his/her motorcycle to the burnout station for a “run.” Also, conventional stationary burnout pits generally accommodate a single motorcycle at a given time.

Accordingly, a more accommodating, less expensive motorcycle burnout pit would be desirable.

### BRIEF SUMMARY OF THE INVENTION

The present invention provides a mobile motorcycle burnout pit that can be set up and used practically anywhere. The mobile burnout pit also provides various desirable accessories, such as an onboard video camera, signal lamps, and a computer that records a burnout performance and produces a recording at the end of the burnout. The mobile burnout pit also preferably accommodates more than one motorcycle at a time.

The mobile motorcycle burnout pit of this invention includes a trailer with forward and rearward ends, a support member adjacent the forward end for receiving and securing a front wheel of a motorcycle in a generally upright position on a floor of the trailer, a pad guide adjacent the rearward end of the trailer, and a replaceable burnout pad received in the pad guide so as to be fixedly secured to the floor of the trailer behind the support member for accommodating a rear wheel of a motorcycle. A video camera and signal lamps are preferably mounted near the forward end of the trailer, and can be connected to a portable computer capable of recording and producing a storage medium, such as a DVD, containing a recording of a burnout from start to finish as signaled by the signal lamp.

In view of the above, it can be seen that a significant advantage of this invention is that the mobile burnout pit provides a portable and relatively inexpensive apparatus for allowing motorcyclist to engage in burnouts as an entertainment attraction. The mobile burnout pit maximizes the entertainment opportunity by enabling contests between multiple motorcyclists and providing a permanent recording of the burnout performance.

Other objects and advantages of this invention will be better appreciated from the following detailed description.

### BRIEF DESCRIPTION OF THE DRAWINGS

FIGS. 1, 2, and 3 are side, rear, and plan views, respectively, of a mobile motorcycle burnout pit on a flatbed trailer in accordance with a first embodiment of this invention.

FIG. 4 is plan view similar to FIG. 3 but with the trailer of the burnout pit of FIGS. 1-3 configured for a single motorcycle.

FIGS. 5, 6, and 7 are side, rear, and plan views, respectively, of a mobile motorcycle burnout pit on a flatbed trailer in accordance with a second embodiment of this invention.

FIG. 8 is plan view similar to FIG. 7 but with the trailer of the burnout pit of FIGS. 5-7 configured for a single motorcycle.

FIGS. 9 and 10 are plan views of the trailer portion of any one of the burnout pits represented in FIGS. 1 through 8, showing the location and orientation of a camera and signal light for a single-motorcycle and two-motorcycle configuration, respectively.

FIG. 11 is a plan view of the burnout pit similar to FIG. 10, modified to have an extended burnout pad sized to accommodate the rear wheels of both motorcycles.

FIG. 12 is a plan view of a burnout pit similar to FIG. 10, further equipped with a water system for wetting the burnout pads.

FIG. 13 is a side view of a front wheel support assembly lying on the bed of the trailer prior to being readied for use.

FIGS. 14 and 15 are side views of the support assembly of FIG. 13 being readied to receive a front wheel of a motorcycle.

FIGS. 16 and 17 are plan views of FIGS. 13 and 15, respectively, with FIG. 17 further showing a front wheel of a motorcycle received in the support member assembly.

### DESCRIPTION OF THE INVENTION

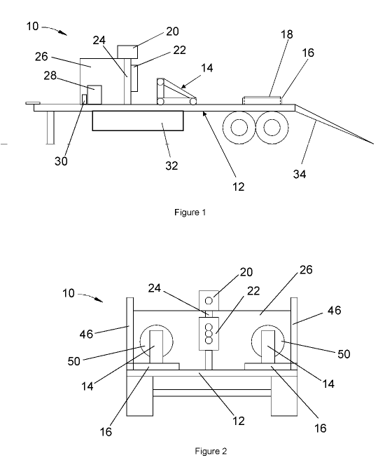

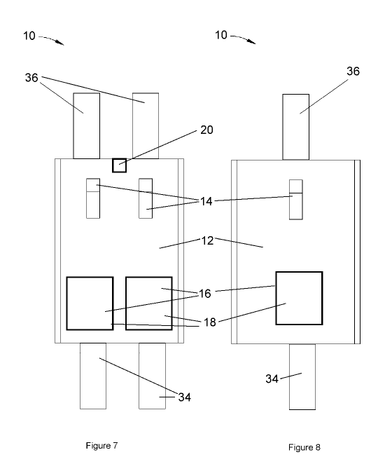

FIGS. 1 through 17 represent embodiments of a mobile burnout pit 10 utilizing a wheeled flatbed trailer 12. FIGS. 1, 2, and 3 are side, rear, and plan views, respectively, of a first embodiment having a front wheel support assembly 14 mounted to the floor of the trailer 12; a pad guide 16 with a replaceable burnout pad 18 on the floor and rearward of the support assembly 14, and a video camera 20 and signal lamp 22 mounted on a stand 24 attached to the floor of the trailer 12 near a forward end of the trailer 12. The signal lamp 22 preferably has red, green, and amber lights to signal the start and stop of a burnout session, during which a motorcycle (not shown) positioned on the trailer 12, with its front wheel secured with the support assembly 14 and its rear wheel positioned on the burnout pad 18, is operated to spin its rear wheel on the burnout pad 18. To obtain the desired effect, the pad 18 is preferably formed of concrete or asphalt, though the use of other materials is foreseeable. The pad 18 is adapted to be removed from the pad guide 16 and replaced when excessive rubber has accumulated on the pad 18. Guardrails 46 (not shown in FIG. 1 for clarity) extend along the length of the trailer 12 to assist the motorcyclist in maneuvering the motorcycle on the trailer 12.

FIG. 1 shows a storage cabinet 26 provided immediately forward of the stand 24 for the purpose of containing a computer 28 and storage device 30, as well as fire extinguishers, additional equipment, and supplies. The computer 28 and storage device 30 are operatively connected with the video camera 20 and the signal lamp 22 to control and time the operation of the camera 20 and lamp 22, and cause the storage device 30 to record the burnout session on a suitable storage medium, such as a DVD, video tape, memory card, etc. FIG. 2 also shows a large fan 50 mounted in the cabinet 26 to force air rearward toward the motorcycle to simulate the wind associated when riding a motorcycle. A second storage cabinet 32 an also be provided beneath the trailer 12. In the embodiment of FIGS. 1, 2, and 3, a rear ramp 34 is attached to the rear end of the trailer 12 to enable a motorcyclist to ride his or her motorcycle up onto the trailer 12. FIG. 4 is a plan view showing how the burnout pit 10 of FIGS. 1, 2, and 3 can be configured for use by a single motorcycle.

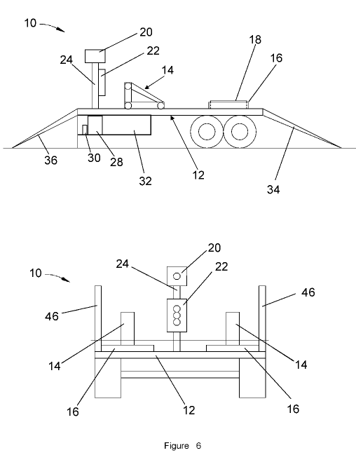

FIGS. 5, 6, and 7 are side, rear, and plan views, respectively, of a second embodiment of the invention, differing from that of FIGS. 1, 2, and 3 by eliminating the forward storage cabinet 26 to permit the addition of front ramps 36 connected to the front end of the trailer 12, thereby enabling the motorcyclists to also exit the trailer by moving forward. Because the forward storage cabinet 26 has been eliminated, the computer 28 and storage device 30 are shown in FIG. 2 as being contained within the lower storage cabinet 32. FIG. 8 is a plan view showing how the burnout pit 10 of FIGS. 5, 6, and 7 can be configured for use by a single motorcycle.

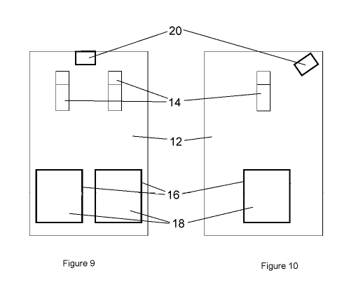

As evident from FIGS. 1 through 8, the video camera 20 and the signal lamp 22 are mounted on the stand 24 so as to face the motorcyclist(s) during a burnout session. Cables (not shown) connecting the video camera 20 and signal lamp 22 can be run inside the stand 24 to the computer 28 and storage device 30. The computer 28 preferably causes the storage device 30 to record a burnout session based on the signals of the signal lamp 22, for example, starting at a red light condition immediately before the start of the session, through amber and green light conditions, to a red light terminating the session. Consistent with the embodiment of FIGS. 5, 6 and 7, the plan view of FIG. 9 shows the stand 24 as being generally positioned at front-center of the trailer 12 to permit two motorcyclists to exit the trailer 12 via the front ramp 36. FIG. 10 is a similar plan view showing the single-motorcycle configuration of the embodiment of FIGS. 5, 6, and 7, with the video camera 20 and signal lamp 22 mounted on the post 24 to one side of the trailer 12. The camera 20 and lamp 22 are shown oriented at sufficient angle to record and be visible, respectively, to the motorcyclist performing the burnout session.

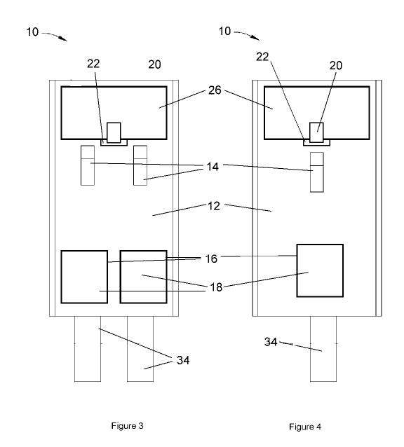

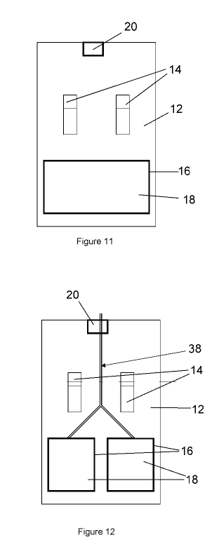

FIGS. 11 and 12 are plan views similar to FIG. 10, showing optional modifications to the burnout pits 10 of this invention. FIG. 11 shows the dual burnout pads 18 of FIGS. 3, 7, and 10 replaced with a single burnout pad 18 that extends sufficiently across the trailer 12 to accommodate the rear wheels of both motorcycles. FIG. 12 shows the burnout pit 10 equipped with a watering system 38 installed on the trailer 12 for connection to an outside water source to slowly deliver water to the upper surface of the burnout pads 18, resulting in the creation of a steam effect during the burnout session as a visual enhancement to the performance.

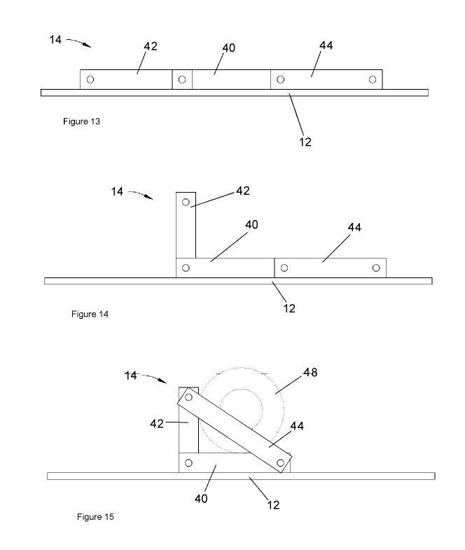

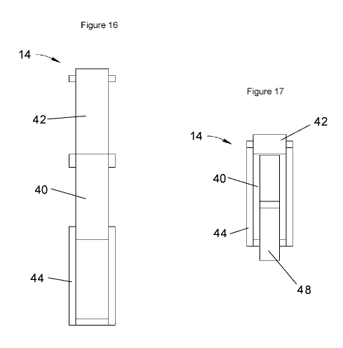

FIG. 13 through 17 illustrate the appearance of the front wheel support assembly 14 during a series of steps as the assembly 14 is prepared to secure the front wheel 48 (FIGS. 15 and 17) of a motorcycle for a burnout session. As represented in FIGS. 13 through 15, the support assembly 14 acquires a triangular shape when assembled, so that the front wheel 48 of the motorcycle is engaged in the support assembly 14 in a generally fixed upright position. The support assembly 14 comprises three elongated members—a middle 40 of the three members is attached to the floor of the trailer 12, while the remaining two members, a leg member 42 and a connection member 44, are connected to forward and rearward ends of the middle member 40 with hinges so that the leg and connection members 42 and 44 can freely pivot about the adjacent ends of the fixed middle member 40. FIG. 14 shows the leg member 42 raised to create an L-shaped configuration with the middle and connection members 40 and 44, and FIGS. 15 and 17 show the connection member 44 latched, pinned, etc., to the raised end of the leg member 42, thereby creating a cradle for a front wheel 48 of the motorcycle (FIG. 17). The connection member 44 maintains the leg member 42 in a generally upright position to prevent a motorcycle from moving forward during a burnout session. As evident from FIGS. 13 and 16, the support assembly 14 is able to lay relatively flat to enable a motorcycle to ride forward off the support assembly 14 and then off the trailer 12 via the front ramp 36 of FIG. 2.

While the invention has been described in terms of preferred embodiment, it is apparent that other forms could be adopted by one skilled in the art. For example, it can be appreciated that the embodiment of FIGS. 1-4 can be adapted for the bed of a truck instead of the trailer 12. Furthermore, the position of the front wheel support assembly 14 and the burnout pads 16 could differ in location, appearance, and construction from that shown and described. Therefore, the scope of the invention is to be limited only by the following claims.

What is claimed is:

1. A mobile motorcycle burnout pit comprising:
a wheeled flatbed having a floor, forward and rearward ends, and two lateral sides;
means for supporting a front wheel of a motorcycle in an upright position on the floor of the flatbed;
a guide fixedly attached to the floor of the flatbed rearward of the front wheel supporting means; and
a burnout pad replaceably secured with the guide on the floor of the flatbed, the burnout pad being sized and located relative to the front wheel supporting means for supporting a rear wheel of the motorcycle.

2. A mobile motorcycle burnout pit according to claim 1, further comprising a video camera mounted near the forward end of the flatbed.

3. A mobile motorcycle burnout pit according to claim 1, further comprising means for video recording a burnout session performed on the flatbed with the motorcycle.

4. A mobile motorcycle burnout pit according to claim 3, further comprising a computer connected to the video recording means and means for producing a stored video record of the burnout session.

5. A mobile motorcycle burnout pit according to claim 1, further comprising a signal lamp mounted near the forward end of the flatbed, and means for controlling the signal lamp to generate signals to start and terminate a burnout session performed on the flatbed with the motorcycle.

6. A mobile motorcycle burnout pit according to claim 1, wherein the front wheel supporting means comprises a first elongate member secured to the floor of the flatbed and oriented in a fore-aft direction of the flatbed, a second elongate member having a first end pivotally attached to a forward end of the first elongate member and an oppositely-disposed second end, a third elongate member having a first end pivotally attached to a rearward of the first elongate member and an oppositely-disposed second end, and means for securing the second ends of the second and third members together to define a cradle for the front wheel of the motorcycle that prevents the front wheel from moving forward on the flatbed.

7. A mobile motorcycle burnout pit according to claim 1, further comprising an entrance ramp attached to the rearward end of the flatbed and configured for enabling the motorcycle to be driven onto the flatbed.

8. A mobile motorcycle burnout pit according to claim 7, further comprising an exit ramp attached to the forward end of the flatbed and configured for enabling the motorcycle to be driven off the flatbed.

9. A mobile motorcycle burnout pit according to claim 1, further comprising at least one fan forward of the front wheel supporting means for blowing air rearward toward the front wheel supporting means.

10. A mobile motorcycle burnout pit according to claim 1, further comprising means for discharging water onto the burnout pad.

11. A mobile motorcycle burnout pit according to claim 1, wherein the burnout pad is formed of a concrete.

12. A mobile motorcycle burnout pit according to claim 1, wherein the burnout pit accommodates at least two motorcycles simultaneously.

13. A mobile motorcycle burnout pit according to claim 1, wherein the flatbed is a trailer.

14. A mobile motorcycle burnout pit comprising:
a wheeled flatbed trailer having a floor, forward and rearward ends, and two lateral sides;
means for supporting a front wheel of a motorcycle in an upright position on the floor of the flatbed;
a guide fixedly attached to the floor of the flatbed rearward of the front wheel supporting means;
a burnout pad replaceably secured with the guide on the floor of the flatbed, the burnout pad being sized and located relative to the front wheel supporting means for supporting a rear wheel of the motorcycle;
means for signaling the start and termination of a burnout session performed on the trailer with the motorcycle while the front wheel of the motorcycle is secured by the front wheel securing means and the rear wheel of the motorcycle is spinning on the burnout pad;
means for video recording the burnout session;
means for producing a stored video record of the burnout session recorded by the recording means; and
means for controlling the signaling means, the recording means, and the producing means to synchronize the signaling means and the recording means and cause the producing means to produce the stored video record.

15. A mobile motorcycle burnout pit according to claim 14, wherein the video recording means is mounted near the forward end of the trailer.

16. A mobile motorcycle burnout pit according to claim 14, wherein the controlling means is operable to start the video recording means on a first light signal from the signaling means and to stop the video recording means on a second light signal from the signaling means.

17. A mobile motorcycle burnout pit according to claim 14, wherein the front wheel supporting means comprises a first elongate member secured to the floor of the flatbed and oriented in a fore-aft direction of the flatbed, a second elongate member having a first end pivotally attached to a forward end of the first elongate member and an oppositely-disposed second end, a third elongate member having a first end pivotally attached to a rearward of the first elongate member and an oppositely-disposed second end, and means for securing the second ends of the second and third members together to define a cradle for the front wheel of the motorcycle that prevents the front wheel from moving forward on the flatbed.

18. A mobile motorcycle burnout pit according to claim 14, further comprising an entrance ramp attached to the rearward end of the flatbed and configured for enabling the motorcycle to be driven onto the flatbed.

19. A mobile motorcycle burnout pit according to claim 18, further comprising an exit ramp attached to the forward end of the flatbed and configured for enabling the motorcycle to be driven off the flatbed.

20. A mobile motorcycle burnout pit according to claim 14, wherein the burnout pit accommodates at least two motorcycles simultaneously.
